(19) United States
(12) Patent Application Publication
(10) Pub. No.: US 2013/0100676 A1
(43) Pub. Date: Apr. 25, 2013

(54) DOWNLIGHT STRUCTURE

(71) Applicant: Chin-Wen WANG, Pingzhen City (TW)

(72) Inventor: Chin-Wen WANG, Pingzhen City (TW)

(73) Assignees: LEADER TREND TECHNOLOGY CORP.; Chin-Wen WANG

(21) Appl. No.: 13/277,102

(22) Filed: Oct. 19, 2011

(51) Int. Cl. F21V 17/02; F21V 29/00

(52) U.S. Cl. 362/282; 362/322

(57) ABSTRACT

The downlight includes a seat, a depressor, a rotator, a deflector and a lamp module. The seat has a hollow and a flange therein. The depressor is fixed on the seat and corresponding to the flange. The rotator is disposed between the flange and the depressor and is capable of rotating against the seat. The deflector is received in the hollow and pivotally connected to the rotator. The lamp module is fastened to the deflector.

### BACKGROUND OF THE INVENTION

1. Technical Field

The invention relates to lights, particularly to downlights (also known as recessed lights, can lights or pot lights).

2. Related Art

A downlight is a light fixture that is installed into a hollow opening in a ceiling. When installed it appears to have light shining from a hole in the ceiling, concentrating the light in a downward direction as a broad floodlight or narrow spotlight. Some downlights are capable of tilting to change their projection directions.

Please refer to FIG. 1, which shows a conventional adjustable downlight. The downlight includes a housing 10, a fixer 20, a lamp module 30 and an arm 40. The housing 10 is used to be fastened to a ceiling. The fixer 20 is on the housing to fasten the arm 40. The lamp module 30 is pivotally connected at an outer end of the arm 40. Thus the lamp module 30 can be adjusted by tilting the arm 40.

However, the whole weight of the lamp module 30 is applied to the arm 40 and fixer 20. The lamp module 30 tends to fall down when anyone of the fixer 20, lamp module 30 and arm 40 comes loose. Furthermore, the arm 40 is a complicated, expensive and unstable component. Such a component is easy to fail because of wearing away or low friction. But adjustment is hard to perform if the arm 40 is assembled to the fixer 20 too tightly. It is disadvantageous to both users and manufactures.

### SUMMARY OF THE INVENTION

An object of the invention is to provide a downlight, which has a simplified and stable angle adjustment mechanism.

To accomplish the above object, the downlight of the invention includes a seat, a depressor, a rotator, a deflector and a lamp module. The seat has a hollow and a flange therein. The depressor is fixed on the seat and corresponding to the flange. The rotator is disposed between the flange and the depressor and is capable of rotating against the seat. The deflector is received in the hollow and pivotally connected to the rotator. The lamp module is fastened to the deflector.

Moreover, the downlight of the invention allows the lamp module to rotate 360 degrees with any tilting angles. This is very useful to users.

### BRIEF DESCRIPTION OF THE DRAWINGS

FIG. 1 shows a conventional downlight;

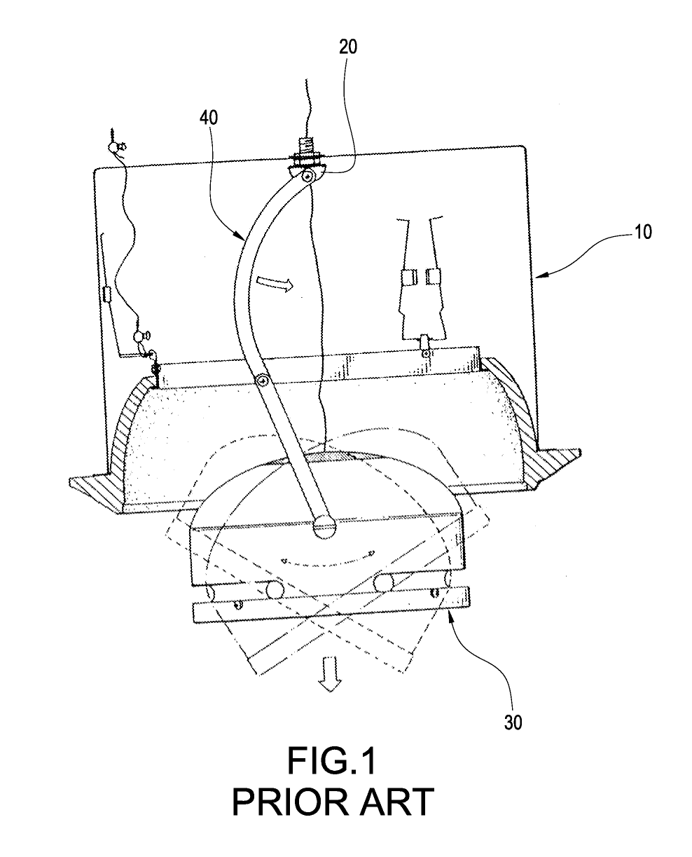

FIG. 2 is an exploded view of the invention;

FIG. 3 is another exploded view of the invention;

FIG. 4 is an assembled view of the invention;

FIG. 5 is a cross-sectional view of the invention;

FIG. 6 is a top view of the invention;

FIG. 7 is a cross-sectional view of the invention in a tilting status;

FIG. 8 is a perspective view of FIG. 7; and

FIG. 9 is another perspective view of FIG. 7.

### DETAILED DESCRIPTION OF THE INVENTION

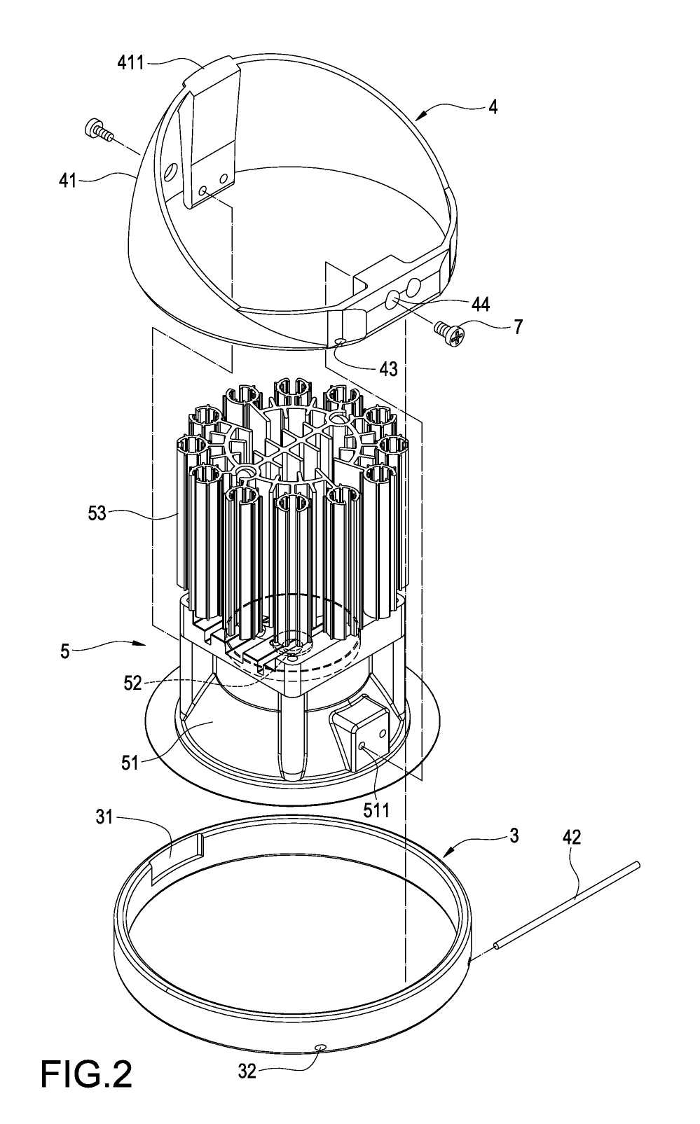

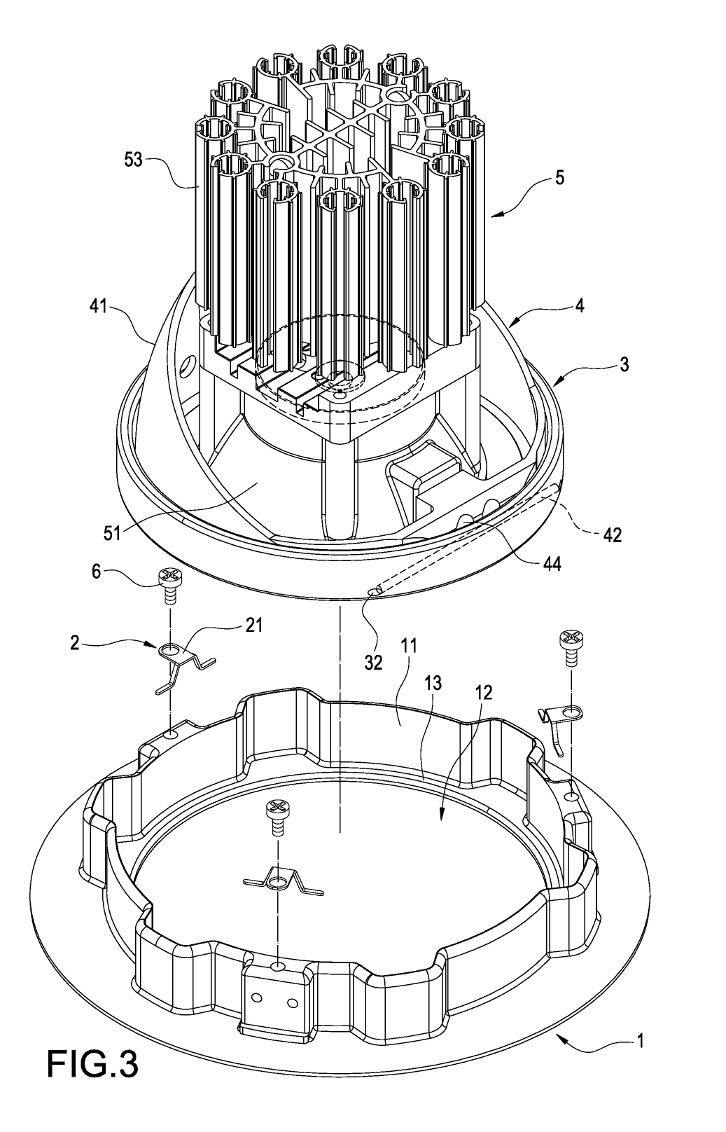

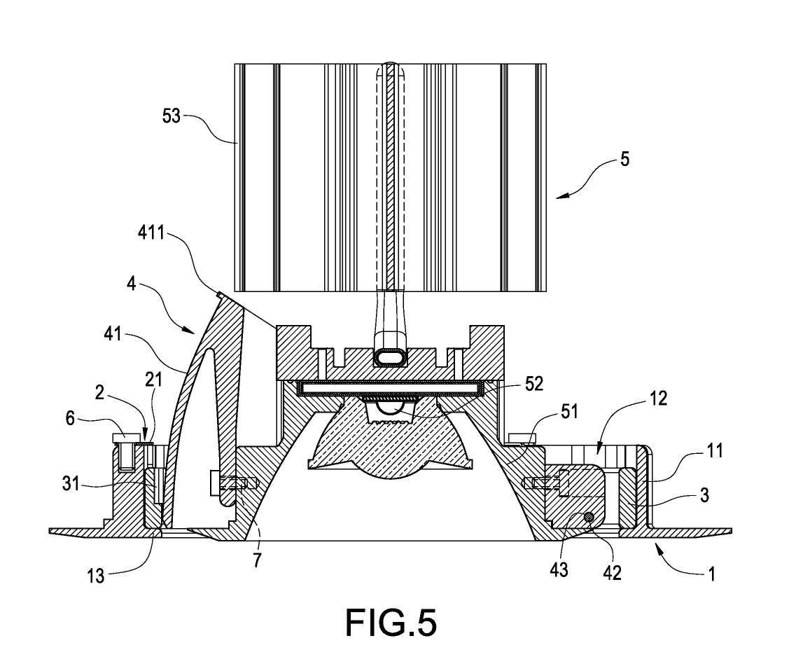

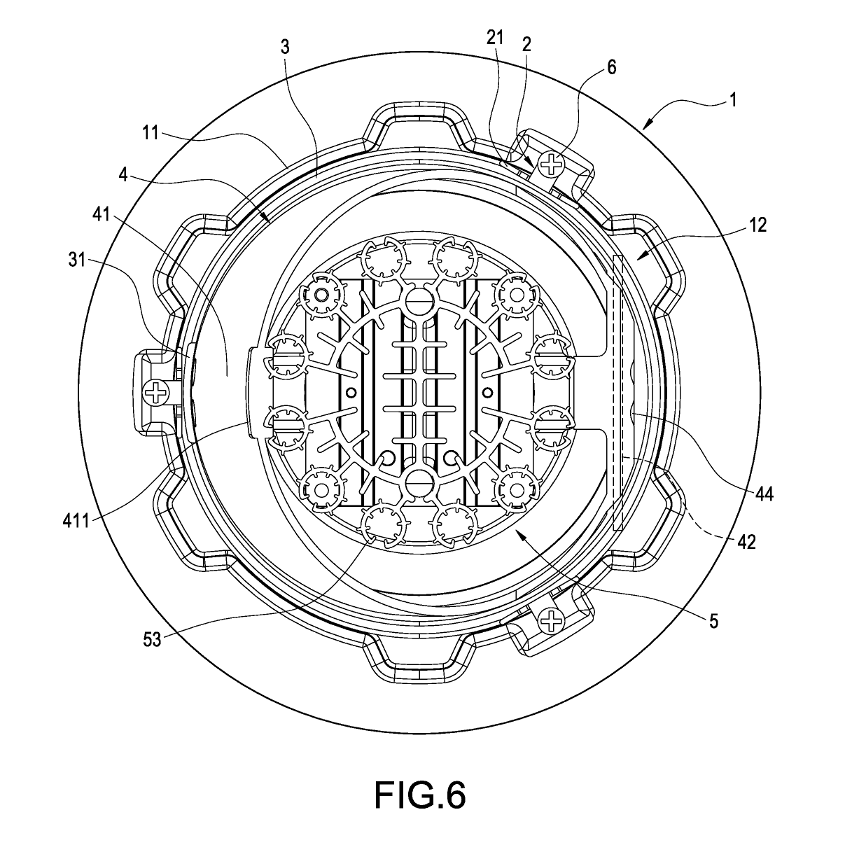

Please refer to FIGS. 2-6. The downlight of the invention includes a seat 1, a depressor 2, a rotator 3, a deflector 4 and a lamp module 5.

The seat 1 is formed with a hollow 12, a flange 13 extending from the hollow 12 and an annular wall 11 around the hollow 12.

The depressor 2 is fixed on the seat 1 and corresponding to the flange 13. The depressor 2 may be, but not limited to, a plurality of elastic pieces 21.

The rotator 3 is of an annular shape and disposed between the flange 13 and depressor 2 so that the rotator 3 can rotate against the seat 1. The rotator 3 is formed with a recess 31 and a first pivot hole 32.

The deflector 4 is received in the hollow 11 and pivotally connected to the rotator 3. The deflector 4 is provided with a second pivot hole 43. The deflector 4 is pivotally connected to the rotator 3 by inserting a pivot 42 into the first pivot hole 32 and the second pivot hole 43. As a result, one side of the deflector 4 is connected to the rotator 3 and the other side thereof forms an adjustment section 41. A protrusion 411 corresponding to the recess 31 is formed on the adjustment section 41. Additionally, the deflector 4 is provided with through holes 44. The deflector 4 is of a hollow shape with a slant to form a low side which connects to the rotator 3 and a high side which is the adjustment section 41.

The lamp module 5 is fastened in the deflector 4 which is of a hollow shape. The lamp module 5 includes a housing 51, a light emitting diode (LED) unit 52 and a heat sink 53. The LED unit 52 and heat sink 53 are separately located on both sides of the housing 51. Additionally, the housing 51 is provided with passing holes 511 corresponding to the through holes 44.

The invention further includes a plurality of fasteners 6 and screws 7. The elastic pieces 21 are separately fixed on the annular wall 11 by the fasteners 6 so that the rotator 3 is gripped between the flange 13 and the elastic pieces 21. The screws 7 separately penetrate the through holes 44 and are separately fastened to the passing holes 511 so that the lamp module 5 and deflector 4 are assembled.

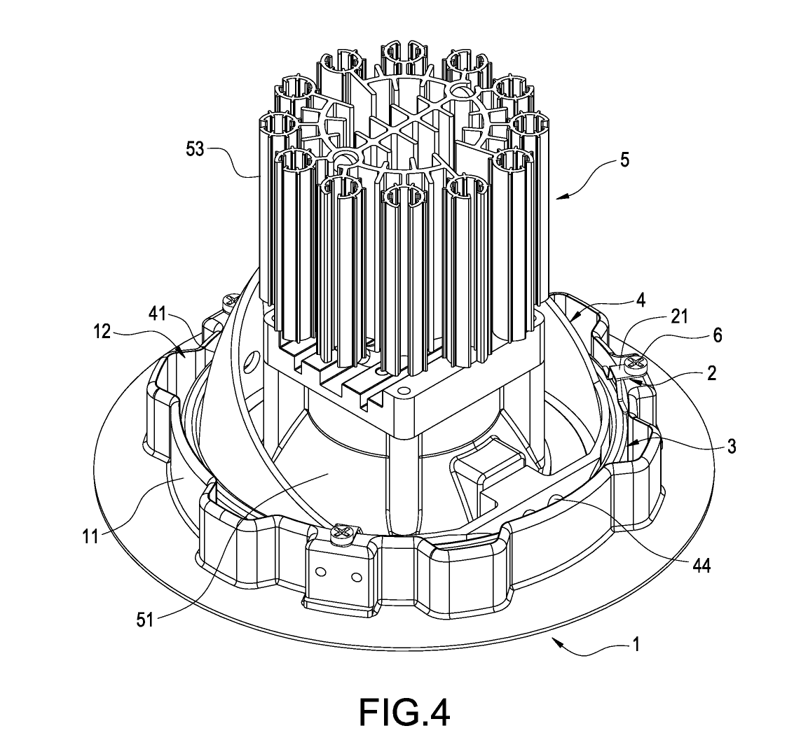

Please refer to FIGS. 4-6. Because the rotator 3 can rotate against the seat 1 and the deflector 4 can tilt against the rotator 3, the lamp module 5 can rotate 360 degrees with tilt adjustment. The light projection direction of the lamp module 5 can satisfy various requirements of users.

Additionally, the flange 13 is an annular body extending from the seat 1, so the whole weight of the rotator 3, deflector 4 and lamp module 5 will be distributed over the seat 1 through the flange. The opening defined by the flange 13 is smaller than the rotator 3, deflector 4 or lamp module 5, so these internal components cannot escape from the seat 1 to fall down even if they are released from each other. This enhances safety of using downlights.

Besides, the invention replaces a halogen bulb with an LED unit 52 and arranges the heat sink 53 for heat dissipation.

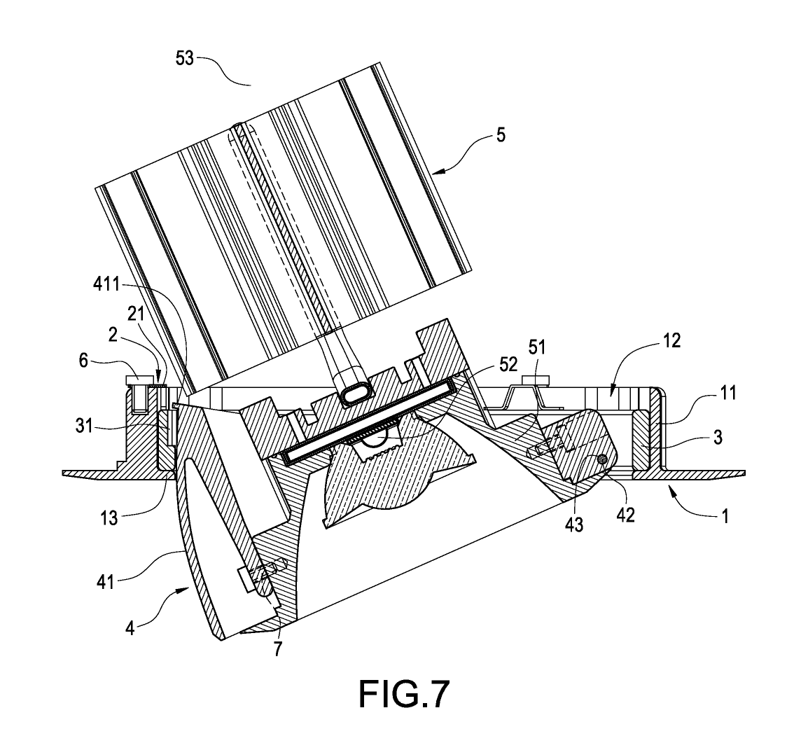

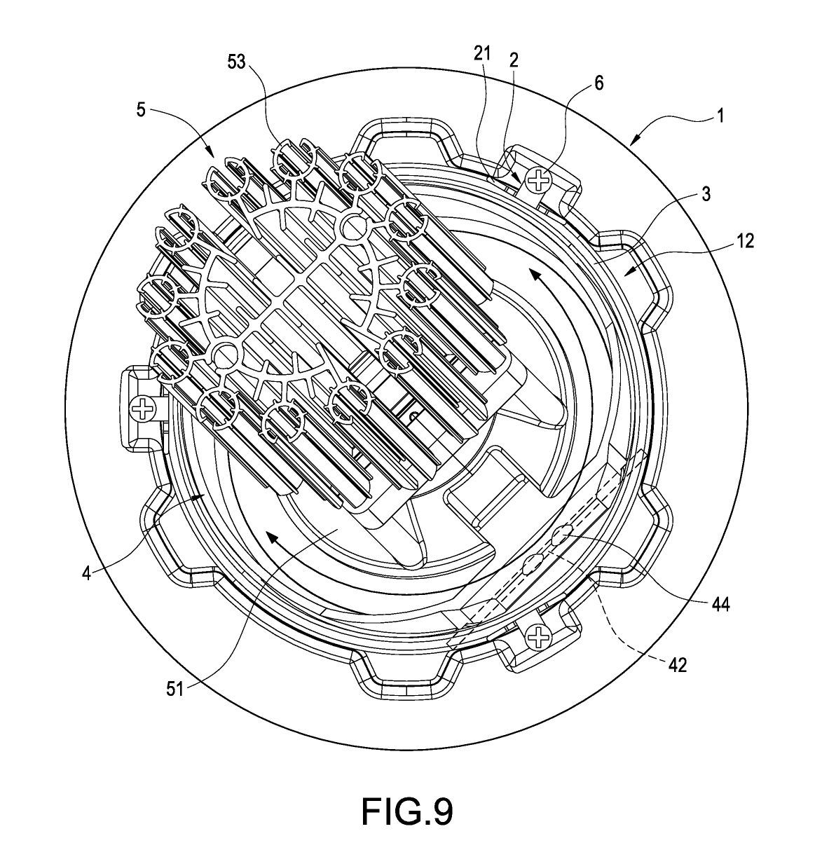

Please refer to FIGS. 7-9. The adjustment section 41 has a larger area and the protrusion 411, so the deflector 4 can be tilted within a wider angle and the deflector 4 can be positioned by the engagement of the protrusion 411 and recess 31. Further, the larger adjustment section 41 is easy to be held by a user.

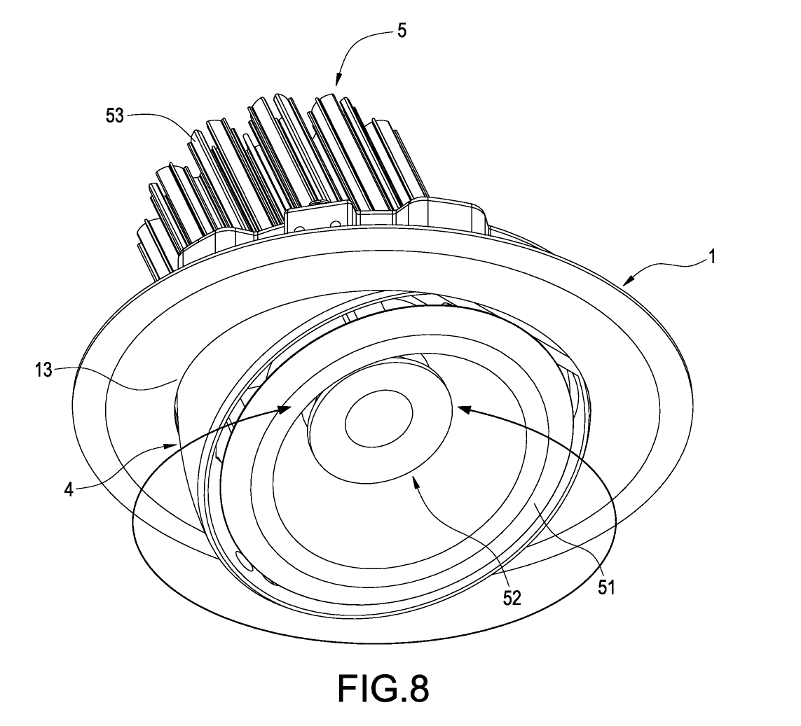

When a user holds the adjustment section 41, as shown in FIG. 8, the rotator 3 is rotated between the flange 13 and depressor 2 to adjust projection of the LED unit 52. Thus, the invention is advantageous to users' operation.

It will be appreciated by persons skilled in the art that the above embodiment has been described by way of example only and not in any limitative sense, and that various alterations and modifications are possible without departure from the scope of the invention as defined by the appended claims.

What is claimed is:

1. A downlight comprising:
a seat having a hollow and a flange therein;
a depressor, fixed on the seat and corresponding to the flange;
a rotator, disposed between the flange and the depressor, and being capable of rotating against the seat;
a deflector, received in the hollow, and pivotally connected to the rotator; and
a lamp module fastened to the deflector.

2. The downlight of claim 1, wherein one side of the deflector is pivotally connected to the rotator, and the other side thereof forms an adjustment section.

3. The downlight of claim 2, wherein a protrusion is formed atop the adjustment section, and a recess is formed in the rotator for engaging with the protrusion.

4. The downlight of claim 2, wherein the rotator is provided with a first pivot hole, the deflector is provided with a second pivot hole, and a pivot penetrates through the first pivot hole and the second pivot hole.

5. The downlight of claim 2, wherein the deflector is of a hollow shape with a slant to form a low side which connects to the rotator and a high side which is the adjustment section.

6. The downlight of claim 1, wherein the depressor is a plurality of elastic pieces.

7. The downlight of claim 6, further comprising a plurality of fasteners and an annular wall formed on the seat, wherein the elastic pieces are separately fixed on the annular wall by the fasteners so that the rotator is gripped between the flange and the elastic pieces.

8. The downlight of claim 1, wherein the lamp module includes a housing, a light emitting diode (LED) unit and a heat sink, and the LED unit and the heat sink are separately located on both sides of the housing.

9. The downlight of claim 1, wherein the deflector is a hollow body for receiving the lamp module.

10. The downlight of claim 9, further comprising a plurality of screws, through holes formed in the deflector and passing holes formed in the lamp module, wherein the screws separately penetrate the through holes and are separately fastened to the passing holes.
